(19) United States
(12) Patent Application Publication
(10) Pub. No.: US 2004/0216569 A1
(43) Pub. Date: Nov. 4, 2004

(54) Cutter, cutting method, apparatus for producing interlabial pad, and method for producing the same

(75) Inventors: Satoshi Mizutani, Kagawa (JP); Masashi Hosokawa, Kagawa (JP); Koichi Yamaki, Kagawa (JP); Yuki Noda, Kagawa (JP)

Correspondence Address: DARBY & DARBY P.C., P. O. BOX 5257, NEW YORK, NY, 10150-5257, US

(73) Assignee: Uni-Charm Corporation, Kawanoe-Shi (JP)

(21) Appl. No.: 10/749,856

(22) Filed: Dec. 31, 2003

(30) Foreign Application Priority Data
Mar. 31, 2003 (JP) 2003-097147

(51) Int. Cl. B26D 1/00

(52) U.S. Cl. 83/13; 30/401

(57) ABSTRACT

The present invention relates, for example, to a cutter, an apparatus for producing an interlabial pad having the cutter, a cutting method, and a method for producing the interlabial pad including the cutting method. The cutter cuts out a member from continuous sheet base material. In accordance with the present invention, separation of the members and the remaining base material is ensured so that disclocation of the cut-out member is prevented from occuring.

### CROSS-REFERENCE TO RELATED APPLICATIONS

This is an application based upon and claims the benefit of priority from the prior Japanese Patent Application No. 2003-097147 filed on Mar. 31, 2003, the entire contents of which are incorporated herein by reference.

### BACKGROUND OF THE INVENTION

1. Technical Field

The present invention relates, for example, to a cutter, an apparatus for producing an interlabial pad comprising the cutter, a cutting method, and a method for producing the interlabial pad comprising the cutting method.

2. Background Art

Conventionally, cutters for cutting continuous sheet base materials have been known (for example, see the Japanese Patent Laid-Open No. 1996-52696). A cutter disclosed in the Japanese Patent Laid-Open No. 1996-52696 comprises, for example, a die cut roller which has a blade and an anvil roller being spaced under the die cut roller. Suction holes are provided in the portion within the blade of the die cut roller.

With this cutter, sanitary products are cut out from a raw material sheet by the blade through supplying the raw material sheet between the rollers. Then, the cut-out sanitary product is conveyed while being kept on the surface of the die cut roller by being sucked with a suction device.

However, with the above-described cutter, a remainder of the raw material sheet after the sanitary product is cut out may interfere with the cut-out sanitary product and cause dislocation of the sanitary product.

### DISCLOSURE OF THE INVENTION

An object of the present invention is to provide a cutter which can prevent the cut-out members being dislocated.

Specifically, the present invention provides the followings.

(1) A cutter for cutting out a member from a continuous sheet base material, comprising: conveying means, for conveying a continuous sheet base material along a continuing direction of the continuous sheet base material; cutting means, having a cutting blade and a driving mechanism for bringing the cutting blade into or from substantially a center in a width direction of the conveyed base material, for cutting out the member by pressing the cutting blade against the base material; member discharging means for discharging the cut-out member; dividing means for dividing a base material remainder, which is a remainder of the base material after the member is cut out, into two parts along the continuing direction of the base material; and base material remainder discharging means for discharging the divided base material remainders in directions away from each other.

Examples of the base material may be absorbent materials which can absorb liquid. Specifically, the absorbent material contains, for example, hydrophilic fibers such as pulp, super absorbent polymer (SAP), synthetic fibers or their mixture. For example, SAP having about 310 g/m² by a weight per unit, pulp having about 400 g/m² by a weight per unit, furthermore, pulp containing about 20 to 30% synthetic fiber by a weight per unit.

Further, the thickness of the base material may be uniform or ununiform.

The cutting blade is an edge, and there is no limit to the number and the shape thereof. The cutting blade may be mounted on the surface of a block or a roller. Also, the cutting blade may be moved relatively in the direction along a surface of the base material when the cutting blade is pressed against the base material. Further, the cutting blade may cut out two members at the same time.

Examples of the conveying means may be a roller, belt conveyer, and the like.

Examples of the member discharging means and the base material remainder discharging means may be free fall of the member or the base material remainder due to its own weight In addition to the roller, the belt conveyer and the like.

The members are used as sanitary products, diapers, and other absorbent articles, and the shapes may be determined as appropriate.

Like the base material, it is preferable that the base material remainder is in a continuous form so that the base material remainder can be easily discharged by simply pulling the base material remainder.

Discharging the two divided base material remainders in directions away from each other may mean to discharge them in such directions that the distance between the two base material remainders after cutting out the members increases. Specifically, the two divided base material remainders may be discharged to be extended on both sides of the discharging direction of the member. At this time, the angle between the discharging directions of the two divided base material remainders and the discharging direction of the base material may be determined as appropriate. However, with a large angle, the member and the base material remainder can be easily separated by utilizing the resistance of the member and the base material remainder to deformation.

According to the present invention, the member and the base material remainder can be surely separated so that the dislocations of the cut-out members can be prevented.

(2) The cutter described above, wherein the base material remainder discharging means discharges the base material remainder in a thickness direction of the member at a predetermined angle to the discharging direction of the cut-out member.

The base material is in a sheet form so that it is difficult to be bent in the width direction. However, it can be easily bent in the thickness direction. Therefore, it is preferable to discharge the two divided base material remainder in the thickness direction at a predetermined angle to the discharging direction of the member.

(3) The cutter described above, wherein the base material remainder discharging means discharges the base material remainder in substantially the same direction as the discharging direction of the member viewed from a width direction of the member.

Substantially the same direction as the discharging direction of the member viewed from the width direction of the member means that there is no above-described predetermined angle in the thickness direction of the member between the discharging direction of the base material remainder and the discharging direction of the member. Therefore, according to the present invention, there is no bending stress in the thickness direction of the base material so that the member can be surely cut out from the base material having small flexural yield strength in the thickness direction.

Also, when the bending rigidity of the member in the thickness direction is high, the member and the base material remainder can be surely separated by, for example, providing the angle between the discharging direction of the member and the discharging direction of the base material remainder to be about 0° viewed from the thickness direction of the member and about 5° viewed from the width direction of the member.

(4) The cutter described above, wherein tensile strength of the base material remainder in the continuing direction is higher than that of the member in the continuing direction.

The base material remainder is divided into two in a direction along the discharging direction of the member. Thus, according to the present invention, the base material remainder can be pulled for discharging thereof even if the tensile strength of the member is low.

(5) The cutter described above, wherein the base material is embossed and an embossing rate of the base material remainder is higher than that of the member.

Embossing includes thermal embossing, ultrasonic sealing and the like. Embossing may be arranged, for example, in lines, dots and the like. When the member is used as an absorbent body of an interlabial pad, it is preferable to be in dots in consideration of the comfortableness of the interlabial pad. In this case, embossing on the base material remainder is preferable to be, for example, within the range of 0.3 to 1.0 mm² arranged at 0.5 to 2 mm intervals.

According to the present invention, the tensile strength increases as the embossing rate increases. Therefore, the tensile strength of the base material remainder can be increased even when the tensile strength of the member is low so that the base material remainder can be surely discharged by pulling.

(6) The cutter described above, wherein said embossing is uniformly applied in the continuing direction of the base material.

According to the present invention, the tensile strength in the continuing direction of the base material can be made uniform so that the base material remainder enables to be prevented from an accidental breaking when the base material remainder is pulled.

(7) The cutter described above, wherein said dividing means divides the base material remainder into two parts by said cutting blade.

The term “dividing one into two” here includes the state where the base material remainder is visually completely separated into two and the state where it is practically separated into two even though the two parts appear to be in contact.

(8) The cutter described above, wherein said dividing means comprises cutting-plane-line-forming means which enables to divide the base material remainder into two parts by forming a cutting plane line on the base material remainder along the continuing direction thereof.

(9) The cutter described above, wherein the cutting plane line is a slit.

The cutting plane line may be formed through the member in the thickness direction or formed into a half-way in the thickness direction of the member. The length and the shape of the cutting plane line are not limited, and it may be in a straight line or a curbed line. Also, the number of the cutting plane line is not specifically limited.

(10) The cutter described above, wherein the driving mechanism comprises a roller and a rotating mechanism for rotating said roller, and the cutting blade is a blade provided on the roller; and wherein the rotating mechanism rotates said roller so that the blade presses against the base material, thereby cutting out the member from the base material.

(11) The cutter described above, wherein the member is an absorbent body.

It is preferable to form the absorbent body with a material which is bulky and hard to be deformed. Examples of the materials for forming the absorbent body may be pulp, chemical pulp, pulverized pulp, rayon, acetate, natural cotton, air laid pulp to which chemical bonding is applied, super absorbent polymer, super absorbent polymer fiber, synthetic fiber, and a material obtained by mixing them appropriately.

Specifically, an example of the absorbent body may be a nonwoven sheet with 50 to 250 g/m² and 2 to 5 mm bulkiness, which is obtained by preparing a sheet through entangling fiber, in which 60 to 90% of rayon or acetate within the range of 1.1 to 6.6 dtex and 10 to 40% of super absorbent polymer fiber are laminated by this mixing ratio, by needling.

(12) An apparatus for producing an interlabial pad, comprising the cutter described above.

(13) A cutting method for cutting out a member by pressing a cutting blade against a continuous sheet base material, comprising the step of: conveying the base material along a continuing direction; cutting out the member by pressing the cutting blade against the base material; discharging the cut-out member; dividing a base material remainder, which is a remainder of the base material after the member is cut out, into two parts along the continuing direction of the base material; and; discharging the divided base material remainders in the directions away from each other.

(14) The cutting method described above, wherein, in the discharging step, the base material remainder is discharged in a thickness direction of the member at a predetermined angle to the discharging direction of the member.

(15) The cutting method described above, wherein, in the discharging step, the base material remainder is discharged in substantially the same direction as the discharging direction of the member viewed from a width direction of the member.

(16) The cutting method described above, wherein the base material is embossed beforehand so as to increase an embossing rate of the base material remainder higher than that of the member.

(17) The cutting method described above, wherein said embossing is uniformly applied on the base material in the continuing direction thereof.

(18) The cutting method described above, wherein, in the cutting step, the base material remainder is divided into two by the cutting blade.

(19) The cutting method described above, wherein, in the cutting step, the base material remainder is divided into two by forming a slit on the base material remainder along the continuing direction.

(20) The cutting method described above, wherein, in said cutting step, the cutting blade is provided on a roller and said cutting blade is pressed against the base material by rotating the roller so as to cut out a member from the base material.

(21) A method for producing an interlabial pad, comprising the cutting method described above.

### BRIEF DESCRIPTION OF DRAWINGS

FIG. 1 is a schematic view showing an apparatus for producing an interlabial pad according to a first embodiment of the present invention.

FIG. 2A is a plan view of an absorbent body in the apparatus for producing an interlabial pad according to the embodiment.

FIG. 2B is an enlarged plan view of an absorbent body produced in the apparatus for producing the interlabial pad according to the embodiment.

FIG. 3 is a perspective view of a cutter according to the embodiment.

FIG. 4A is a side view showing the state where the absorbent body is cut out in the cutter according to the embodiment.

FIG. 4B is a side view showing the state where there is a crack generated at the end part of the absorbent body in the cutter according to the embodiment.

FIG. 4C is a side view showing the state where the crack in the end part of the absorbent body is to be expanded in the cutter according to the embodiment.

FIG. 4D is a side view showing the state where the crack in the end part of the absorbent body has expanded in the cutter according to the embodiment.

FIG. 5 is a schematic view of a cut pattern of the cutter according to the embodiment.

FIG. 6 is a schematic view showing a cut pattern of a cutter according to a second embodiment of the present invention.

FIG. 7 is a perspective view showing a cutter according to a comparative example of the present invention.

FIG. 8A is side view showing the state where the absorbent body is cut out in the cutter according to the comparative example.

FIG. 8B is a side view showing the state where there is a crack generated at the end part of the absorbent body in the cutter according to the comparative example.

FIG. 8C is a side view showing the state where the crack in the end part of the absorbent body is to be expanded in the cutter according to the comparative example.

FIG. 8D is a side view showing the state where the absorbent body, together with the base material remainder, moves in the take-up direction in the cutter according to the comparative example.

FIG. 9 is a schematic view showing a cutter according to a third embodiment of the present invention.

FIG. 10 is a plan view of a continuous base material according to the embodiment.

FIG. 11 is a perspective view of a cutter according to a fourth embodiment of the present invention.

FIG. 12 is a perspective view of a continuous base material produced in a cutter according to a fifth embodiment of the present invention.

FIG. 13 is a perspective view of a cutter according to a sixth embodiment of the present invention.

### PREFERRED EMBODIMENTS OF THE INVENTION

Embodiments of the present invention will be described hereinafter by referring to the accompanying drawings. In the description of the embodiments below, the same numerals are applied to the same structural elements and the description therefore will be omitted or simplified.

First Embodiment

Structure of an Apparatus for Producing Interlabial Pad

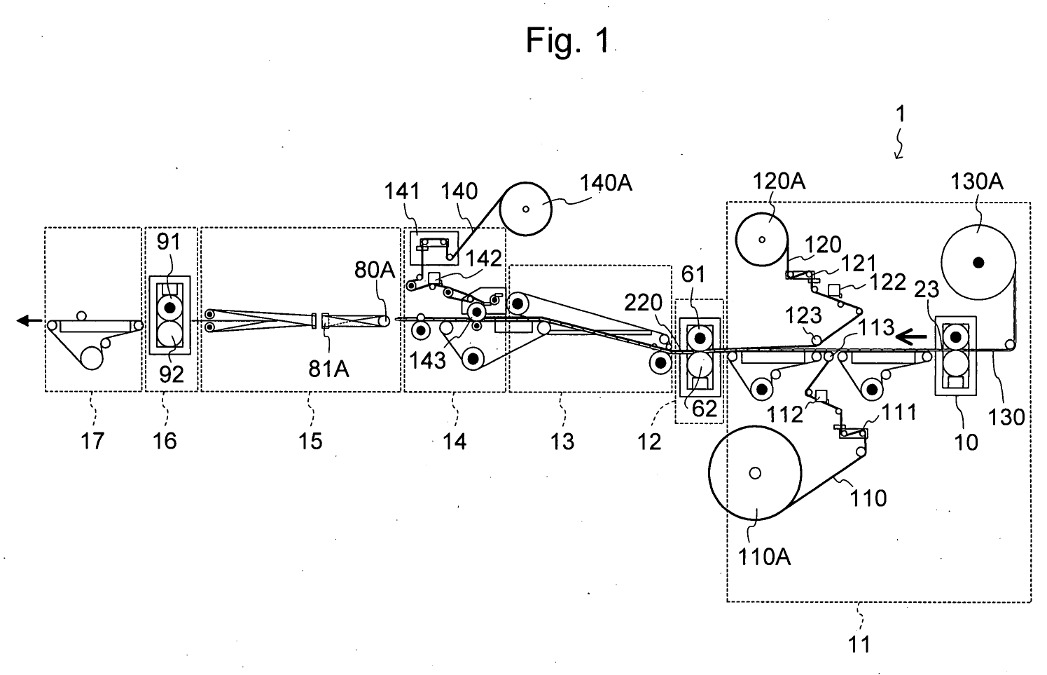

FIG. 1 shows an apparatus for producing an interlabial pad comprising a cutter according to the first embodiment of the present invention.

An interlabial pad producing apparatus 1 includes a raw material supplier 11, a bonding-fixing unit 12, a protruded-area forming unit 13, a mini-sheet piece attaching unit 14, a folding unit 15, a cutting unit 16, and a product conveyer 17.

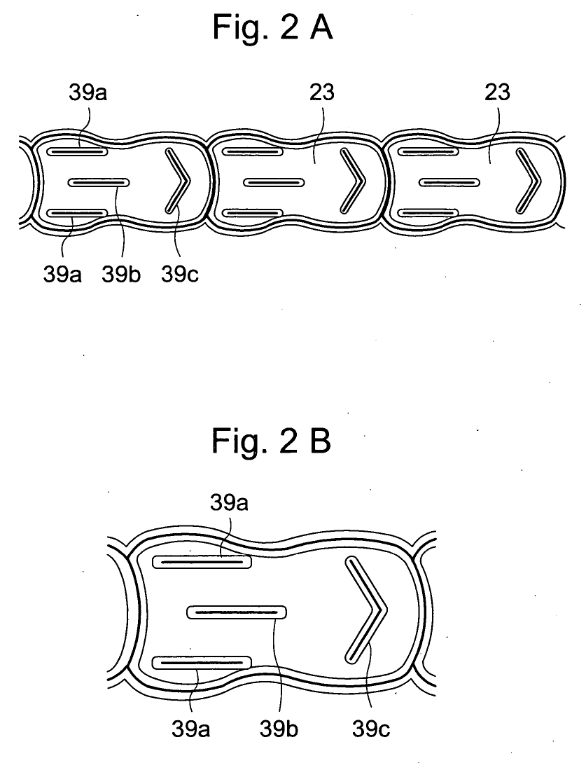

In the raw material supplier 11, a continuous base material 130 wound on a raw material roller 130A is fed from the raw material roller 130A to a cutter 10. In the cutter 10, absorbent bodies 23 are cut out from the continuous base material 130 (see FIG. 2A), and the absorbent bodies 23 are transferred in the arrow direction. The cutter 10 will be described later.

As shown in FIG. 2A and FIG. 2B, four slits 39a, 39b, 39c are formed in the absorbent body 23 by the cutter 10. The center slit 39b is formed so that the absorbent body 23 can be easily bent. The both ends slits 39a are formed so that the mini-sheet piece to be described later can be easily attached. The mountain-shaped slit 39c is formed for fitting fingers of a wearer to the interlabial pad when the pad is worn.

In the raw material supplier 11, a top sheet continuous member 110 wound on a raw material roller 110A is fed to an adhesive-applying device 112 from the raw material roller 110A through a meander-correcting device 111. Then, a hot-melt adhesive is applied onto the top sheet continuous member 110 in the adhesive-applying device 112, and it is sent over a roller 113.

Further, in the raw material supplier 11, a back sheet continuous member 120 wound on a raw material roller 120A is fed to an adhesive-applying device 122 from the raw material roller 120A through a meander-correcting device 121. Then, hot-melt adhesive is applied onto the back sheet continuous member 120 in the adhesive-applying device 122 and it is sent under a roller 123.

Thereby, the top sheet continuous member 110 and the back sheet continuous member 120 sandwich therebetween the absorbent body 23.

In the bonding-fixing unit 12, the top sheet continuous member 110, the back sheet continuous member 120, and the absorbent body 23 are pressed between an upper shaft roller 61 and a lower shaft roller 62. Thereby, the top sheet continuous member 110 and the back sheet continuous member 120 are bonded and fixed with the absorbent body 23 therebetween, and a continuous absorbent layer 220 is formed.

In the protruded-area forming unit 13, the continuous absorbent layer 220 is made into a V-shape toward the downstream. Thus, the absorbent member of the complete interlabial pad has a convex protruded area along the center line.

In the mini-sheet piece attaching unit 14, a mini-sheet piece continuous member 140 wound on a raw material roller 140A is fed to an adhesive-applying device 142 from the raw material roller 140A through a meander-correcting device 141. Then, hot-melt adhesive is applied onto the mini-sheet piece continuous member 140 in the adhesive-applying device 142.

The mini-sheet piece continuous member 140 to which the hot-melt adhesive is applied is kept on a roller with suction 143. In this state, it is cut into a predetermined length by a cut roller including a cutting blade.

The mini-sheet piece cut into the predetermined length is sent to the back sheet continuous member 120 side of the continuous absorbent layer 220 and laminated with the continuous absorbent layer 220 being bent in V-letter shape.

A folding unit 15 includes a roller 80A, a roller 81A orthogonally provided on the roller 80A, and a conveyer belt wound around the rollers 80A and 81A.

The continuous absorbent layer 220 is conveyed on the conveyer belt so that both sides of the continuous absorbent layer 220 are folded. Then, the folded continuous absorbent layer 220 gradually is changed to the horizontal position.

The cutting unit 16 includes a lower shaft roller 92, and an upper shaft roller 91 having a cutter blade. In the cutting unit 16, the lower shaft roller 92 and the upper shaft roller 91 press and cut the continuous absorbent layer 220 with mini-sheet piece so as to form an elliptic-shape interlabial pad.

Completed individual interlabial pads formed as described are conveyed by the product conveyer 17 and then go through wrapping and packaging steps for shipment.

Structure of Cutter

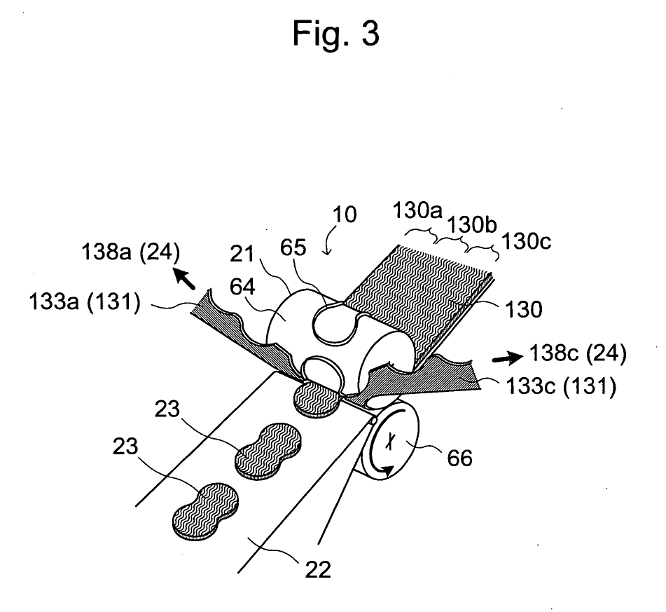

FIG. 3 shows the cutter 10.

The cutter 10 includes a cutting mechanism 21 for cutting out the absorbent bodies 23 from the continuous base material 130 as well as for forming trim absorbent bodies 133a and 133c by dividing a base material remainder 131, which is the remainder of the continuous base material 130 after the absorbent body 23 is cut out thereof, into two. Also, the cutter 10 includes a transporting conveyer 22 as member discharging means for discharging the absorbent bodies 23 and a base material remainder discharging mechanism 24 as base material remainder discharging means for discharging each of the trim absorbent bodies 133a and 133c toward the directions away from each other.

The cutting mechanism 21 includes a cutting roller 64, a driving motor (not shown) as a driving mechanism for rotating the cutting roller 64, and a backing roller 66 arranged at a predetermined space between the cutting roller 64.

A cutting blade 65 having the edge at the end portion protrudes from the cutting roller 64. Also, inside the cutting blade 65, a sponge with high rebound elasticity is provided partially or entirely.

The backing roller 66 is pressed against the cutting roller 64 with a predetermined pressure, and the surface of the backing roller 66 is made soft so as not to damage the edge of the cutting blade 65. The rotation of the backing roller 66 synchronizes with the rotation of the cutting roller 64 so that no shear force occurs in the cutting blade 65.

The continuous base material 130 is a continuous sheet and includes center part 130, and two side parts 130a, 130c in the width direction.

The continuous base material 130 wound on the raw material roller 130A (see FIG. 1) is supported by the raw material roller 130A at its one end and pinched between the cutting roller 64 and the backing roller 66 at the other end, and placed a predetermined tension on thereto.

The base material remainder discharging mechanism 24 includes a suction device (not shown) for sucking each of the trim absorbent bodies 133a, 133c in the directions of arrows 138a and 138c shown in FIG. 3, and take-up devices (not shown) for taking up each of the trim absorbent bodies, respectively, which are sucked by the suction device.

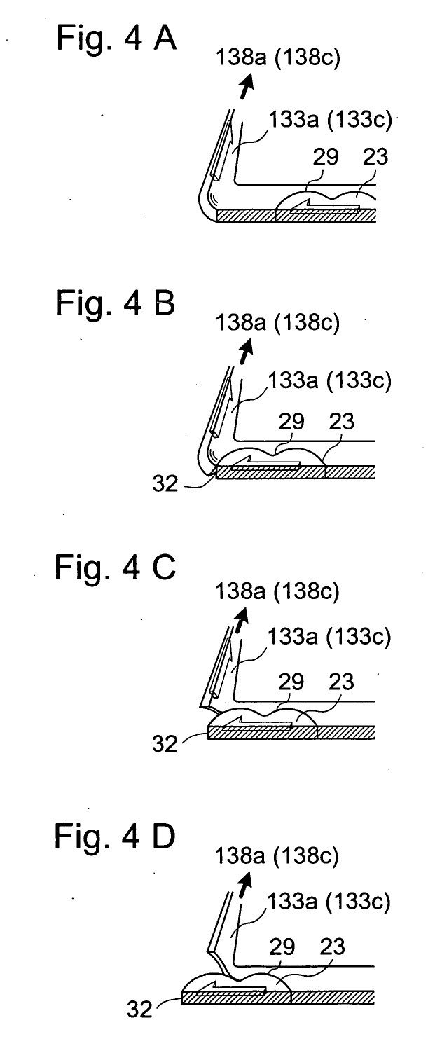

With the cutter 10 as described, upon starting the driving motor, the cutting roller 64 rotates and the continuous base material 130 is conveyed from the raw material roller 130A toward the cutting device 10 along its continuing direction. At the same time, due to the rotation of the cutting roller 64, the cutting blade 65 approaches substantially the center of the continuous base material 130 in the width direction to press against the continuous base material 130. Thereby, there is a cutting plane line 29 (see FIG. 4A to FIG. 4D) formed on the continuous base material 130 by the cutting blade 65 of the cutting roller 64, and the absorbent body 23 as a member in a predetermined shape is cut out from the center part 130b. The absorbent body 23 is pushed out by the rotation of the cutting roller 64 and conveyed on the transporting conveyer 22.

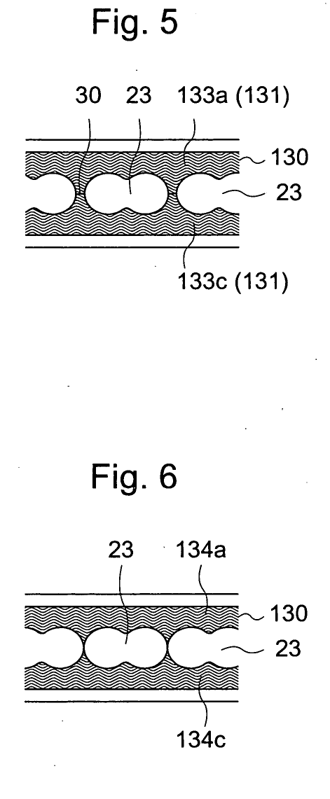

On the other hand, the base material remainder 130, which is the remainder of the continuous base material 131 after the absorbent body 23 is cut out, is cut into two in the continuing direction of the continuous base material 130 by the cutting plane lines 29, 30 (see FIG. 5) formed by the cutting blade 65, and thereby formed into the trim absorbent bodies 133a, 133c. The trim absorbent bodies 133a, 133c are discharged by the base material remainder discharging mechanism 24 in the directions away from each other, that is, in the directions of arrows 138a, 138c.

the directions of taking up the trim absorbent bodies 133a, 133c (directions of arrows 138a, 138c) by the base material remainder discharging mechanism 24 and the discharging direction of absorbent body 23 make a predetermined angle in the thickness direction of the absorbent body 23. Specifically, the predetermined angle may be within the range of 0° to 45°. With this, the absorbent body 23 is not to interfere with the trim absorbent bodies 133a, 133c much so that it is possible to suppress the dislocation.

Operation of the cutter 10 when cutting out the absorbent body 23 from the continuous base material 130 will be described in detail by referring to FIG. 4A to FIG. 4D.

First, the absorbent body 23 is cut out in the shape of the absorbent body along the cutting plane line 29 by the cutting blade 65. In this state, the absorbent body 23 is not separated from the trim absorbent bodies 133a, 133c (FIG. 4A).

Next, the end portion of the absorbent body 23 begins to be discharged from the cutting mechanism 21. At the same time, each of the trim absorbent bodies 133a, 133c, which are the remainder of the continuous base material after the absorbent body 23 is cut out, are brought out in the directions of the arrows 138a, 138c respectively. The force for pulling out each of the trim absorbent bodies 133a, 133c works on the end portion of the absorbent body 23, so that a crack 32 occurs in the bottom tip of the end portion of the absorbent body 23 (FIG. 4B).

The crack 32 expands along the cutting plane line 29 and the absorbent body 23 begins to be separated (FIG. 4C and FIG. 4D). As a result, the absorbent body 23 is completely separated from the continuous base material 130.

The embodiment, as shown in FIG. 5, adopts a cut pattern formed from the absorbent bodies 23 on the continuous base material 130 at predetermined intervals. Here, a cutting plane line 30 is formed between the adjacent ends of the absorbent bodies 23.

Thereby, the base material remainder 131 can be divided easily into the trim absorbent bodies 133a, 133c. Also, the adjacent cutting plane lines of the absorbent bodies 23 do not cross each other. Thus, the amount of scraps generated, when the absorbent bodies 23 is cut out, can be decreased.

With the embodiment, following effects can be expected.

The cutter 10 is formed includes the cutting mechanism 21, the transporting conveyer 22, and the base material remainder discharging mechanism 24. Thereby, the cutter 10 divides the base material remainder 131, which is the remainder of the continuous base material 130 after the absorbent body 23 is cut out, into two for forming the two trim absorbent bodies 133a, 133c, and separates the trim absorbent bodies 133a, 133c from each other. Therefore, the trim absorbent bodies 133a, 133c do not interfere with the end of the absorbent body 23. As a result, the absorbent bodies 23 are smoothly brought out by the transporting conveyer 22 from the two rollers 64 and 66. Thus, the dislocations of the absorbent bodies 23 can be prevented

Since a sponge is provided in the inner side of the cutting blade 65 of the cutting roller 64, rebound elasticity of the sponge works when the cutting roller 64 is pressed against the continuous base material 130. Thus, the pressing force of the cutting blade 65 against the continuous base material 130 can be made uniform and the absorbent bodies 23 can be smoothly cut out.

Also, with the interlabial pad producing apparatus 1, the absorbent bodies 23 for forming the interlabial pads can be stably produced from the continuous base material 130.

Second Embodiment

FIG. 6 shows the cut pattern of a cutter according to the second embodiment of the present invention. The embodiment differs from the first embodiment in respect of the cut pattern formed from the absorbent bodies 23 continuously on the continuous base material 130.

With the embodiment, the amount of the trim taken up in trim absorbent bodies 134a, 134c can be decreased.

### COMPARISON EXAMPLE

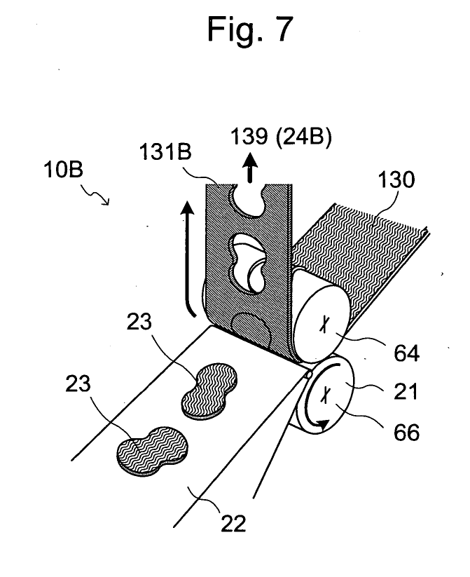

FIG. 7 shows a cutter 10B according to a comparison example of the present invention.

In the comparison example, the structure of a base material remainder discharging mechanism 24B is different from that of the first embodiment.

Specifically, in the comparison example, the base material remainder discharging mechanism 24B does not divide a base material remainder 131B into two but sucks it to the direction of an arrow 139 shown in FIG. 7, that is, in the orthogonal direction to the discharging direction of the absorbent bodies 23.

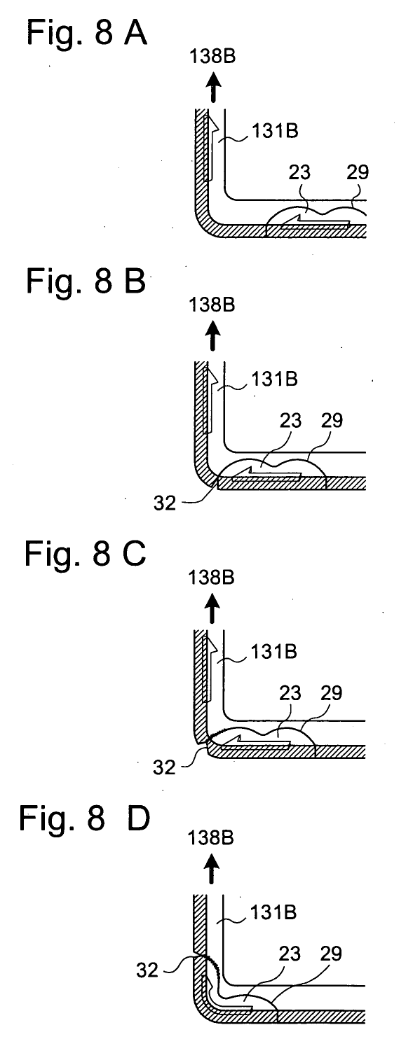

Operation of the cutter 10B for cutting out the absorbent body 23 of the continuous base material 130 will be described in detail by referring to FIG. 8A to FIG. 8D.

First, the continuous base material 130 is cut out along the cutting plane line 29 by the cutting blade 65 in the shape of the absorbent body 23 (FIG. 8A).

Next, the end portion of the absorbent body 23 begins to be discharged from the cutting mechanism 21. At the same time, the base material remainder 131B, which is the remainder of the continuous base material 130 after the absorbent body 23 is cut out, is brought out in the direction of the arrow 139. The force for pulling out each of the base material remainder 131B works on the end portion of the absorbent body 23, so that a crack 32 occurs in the bottom tip of the end portion of the absorbent body 23 (FIG. 8B).

The crack 32 is to expand along the cutting plane line 29. However, the end portion of the absorbent body 23 interferes with the end edge of the base material remainder 131B. Thus, the end portion of the absorbent body 23 clings to the end edge of the base material remainder 131B so as to be brought toward the direction of the arrow 139 together with the base material remainder 131B (FIG. 8C and FIG. 8D). As a result, the absorbent body 23 cannot be completely separated from the continuous base material 130.

Third Embodiment

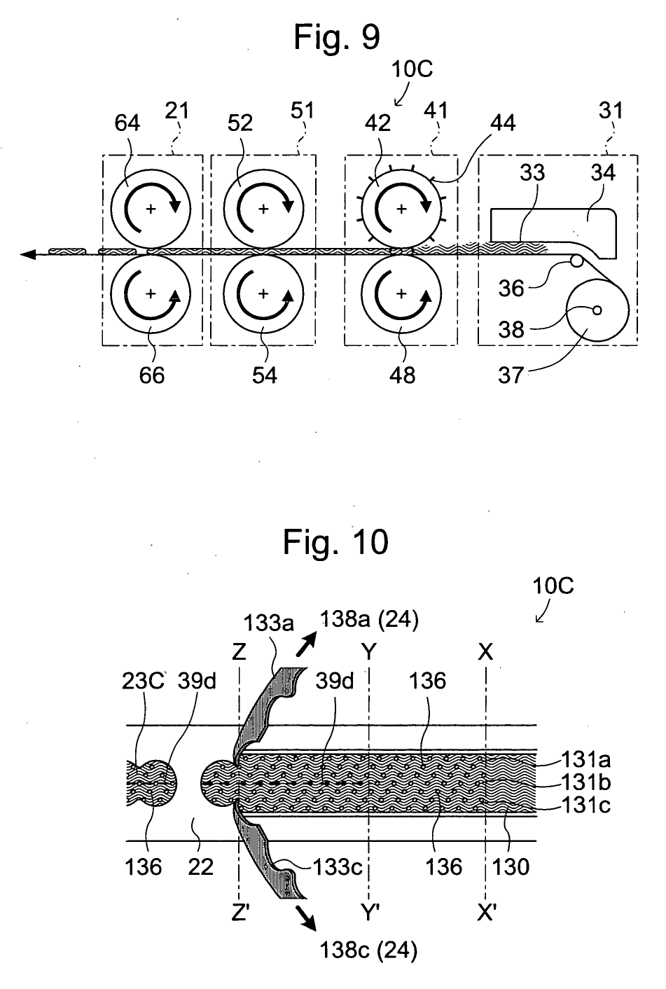

FIG. 9 and FIG. 10 show a cutter 10C according to the third embodiment of the present invention.

The embodiment differs from the first embodiment in respect that it includes an embossing device 41 and a slit forming device 51.

The cutter 10C includes the cutting mechanism 21, the transporting conveyer 22, and the base material remainder discharging mechanism 24. The cutter 10C further includes the embossing device 41 and the slit forming device 51 as a cutting plane line forming means. The embossing device 41 is provided along the line X-X′ shown in FIG. 10, the slit forming device 51 is provided along the line Y-Y′ shown in FIG. 10, and the cutting mechanism 21 is provided along the line Z-Z′.

In the embodiment, the continuous base material 130 is fed by the sheet fabric supplier 31. The sheet fabric supplier 31 is for forming the continuous base material 130 and includes a spool 38 on which a sheet fabric 37 for the absorbent body is wound, a roller 36, and an opening/laminating device 34 for supplying the absorbent material.

The embossing device 41 is for embossing the continuous base material 130 and includes an embossing roller 42 having protruded parts for forming dented embossed parts 136 on the continuous base material 130, as well as an embossing backing roller 48 having a smooth surface.

The slit forming device 51 includes a slit roller 52 having a blade and a backing roller 54 having a smooth surface. The slit forming device 51 forms slits as perforation cutting plane lines in the center of the width direction along the continuing direction of the continuous base material 130 by pressing the slit roller 52 thereto.

The sheet fabric 37 used for the absorbent body is fed to the opening/laminating device 34 through the spool 38 and the roller 36. The absorbent material is supplied from a supply port 33 of the opening/laminating device 34 on top of the sheet fabric 37. The absorbent material is opened and the coating material is laminated, so that the continuous base material 130 is formed.

Then, the continuous base material 130 is embossed by the embossing device 41.

Subsequently, the continuous base material 130 is supplied in between the slit roller 52 and the backing roller 54, and a perforation slit 39d is formed thereon in substantially the center of width direction in the continuing direction of the continuous base material 130.

Then, absorbent bodies 23C are cut out from the continuous base material 130 by the cutter 10 and discharged as they are. At the same time, the base material remainder 131 is pulled by the base material remainder discharging mechanism 24 in the directions of the arrow 138a, 138c. Thus, the base material remainder 131 is torn along the slit 39d to be divided into the trim absorbent bodies 133a, 133c and pulled out.

With the embodiment, the perforation slit 39d is formed in substantially the center of the continuous base material 130 in the continuing direction. Thus, the interlabial pad can be folded along the slit 39d as to improve the fit to the inner wall of the labium.

Further, embossing the continuous base material 130 can improve the tensile strength of each of the trim absorbent bodies 133a, 133c. Therefore, each of the trim absorbent bodies 133a, 133c can be surely pulled out by the suction device.

In consideration of suppressing the deformation of the interlabial pad when worn and maintaining the softness, the embossing rate of the absorbent body 23 per area is preferable to be within the range of 0.5 to 10% and more preferable to be 1.0 to 5.0%. In consideration of suppressing the breakage of the trim absorbent bodies 133a, 133c, the embossing rate of the trim absorbent bodies 133a, 133c per area is preferable to be 15% or more and more preferable to be 40% or more.

Fourth Embodiment

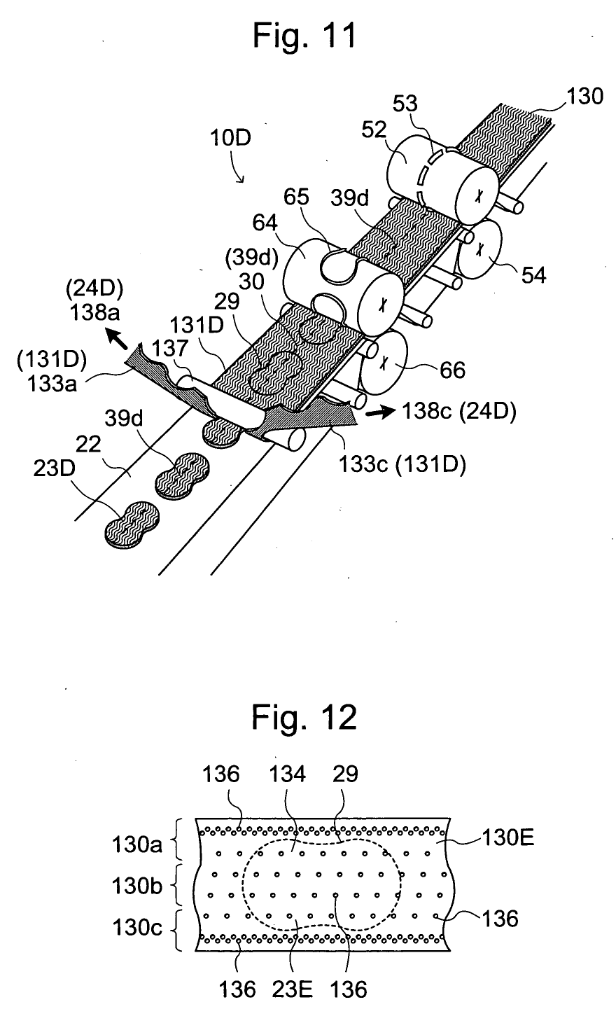

FIG. 11 shows a cutter 10D according to the fourth embodiment of the present invention.

The embodiment differs from the third embodiment in the respect that it does not include an embossing device. Also, the embodiment differs in respect of the structure of a base material remainder discharging mechanism 24D.

Specifically, after absorbent bodies 23D are cut out by the cutting mechanism 21, the absorbent bodies 23D and the base material remainder 131D are discharged by the transporting conveyer 22. Then, on the roller 137, the base material remainder 131D is pulled in the directions of the arrows 138a, 138c to be divided into two trim absorbent bodies 133a, 133c and pulled out.

In the embodiment, the absorbent bodies 23D are discharged along the continuing direction of the continuous base material 130 after the absorbent bodies 23D are cut out, so that dislocations can be further suppressed.

Fifth Embodiment

FIG. 12 shows a continuous base material 130E which is processed by a cutter according to a fifth embodiment of the present invention.

The embodiment differs from the fourth embodiment in respect to the embossing rate of the continuous base material 130E.

Specifically, embossing rate of side portions 130a, 130c of the continuous base material 130E is higher than that of the center portion 130b, and the embossed portion 136 is uniformly formed along the continuing direction of the continuous base material 130E. Therefore, the embossing rate of the trim absorbent body becomes higher than that of the absorbent body 23E.

Thereby, the strength of the trim absorbent body can be improved, so that it enables to prevent the breakage of the trim absorbent body when the trim absorbent body is being pulled.

Also, even though plural numbers of sheets are laminated to form the continuous base material 130E, the plural numbers of sheets are unified by embossment. Thus, the trim absorbent body can be surely pulled out.

Examples of the absorbent body 23E may be rayon, acetate, natural cotton, super absorbent polymer fiber, synthetic fiber, pulp, chemical pulp, and mixtures of them. In consideration of softness of the absorbent body, the absorbent body is preferable to be an aggregate of fibers which mainly contains rayon with the fiber length of 10 to 51 mm. In this case, the pitch of the embossment in the embossed portion 136 is preferable to be within the range of 1 to 9 mm.

Sixth Embodiment

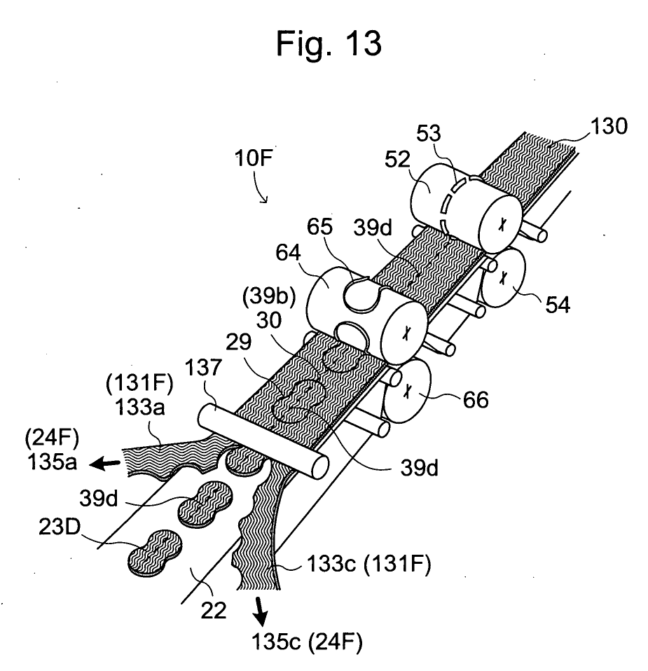

FIG. 13 shows a cutter 10F according to a sixth embodiment of the present invention.

The embodiment differs from the fourth embodiment in respect of the structure of a base material remainder discharging mechanism 24F.

Specifically, a base material remainder 131F is pulled 137 in the directions of 135a, 135c on the roller so as to be divided into two trim absorbent bodies 133a, 133c and pulled out. The directions of the arrows 135a, 135c are substantially the same directions as the discharging direction of the absorbent bodies 23 viewed from the width directions of the absorbent body 23D, that is, in the horizontally expanding directions.

In the embodiment, the absorbent bodies 23D are not pulled in the thickness direction, so that dislocations of the absorbent bodies 23D can be more surely suppressed.

The present invention is not limited to the above-described embodiments but it includes various modifications and improvements which achieve the object of the invention.

For example, in the production lines of the interlabial pad producing apparatus 1, for example, the speed of the line may be set to be about 20 to 200 m/min. And the production rate of the absorbent bodies may be set to be about 200 to 2000 pieces per minute.

Further, in the first embodiment, the tensile strength of the side portions 130a, 130c of the continuous base material 130 in the continuing direction, from which the trim absorbent bodies 133a and 133c are formed, may be set larger than that of the center portion 130b from which the absorbent bodies 23 are formed. With this, rigidity of the trim absorbent body can be increased while the softness of the absorbent bodies 23 is maintained. Also, the trim absorbent bodies 133a, 133c enable to prevent breakage when pulled out.

According to the cutter, cutting method, an apparatus for producing the interlabial pad, and a method for producing the same, the member and the base material remainder can be surely separated. Thus, the dislocations of the cut-out members can be prevented.

1. A cutter for cutting out a member from a continuous sheet base material, comprising:
conveying means for conveying a continuous sheet base material along a continuing direction of the continuous sheet base material;
cutting means, having a cutting blade and a driving mechanism for bringing said cutting blade into or from substantially a center in a width direction of the conveyed base material, for cutting out the member by pressing said cutting blade against the base material;
member discharging means for discharging the cut-out member,
dividing means for dividing a base material remainder, which is a remainder of the base material after the member is cut out, into two parts along the continuing direction of the base material; and
base material remainder discharging means for discharging the divided base material remainders in directions away from each other.

2. The cutter according to claim 1, wherein said base material remainder discharging means discharges the base material remainder in a thickness direction of the member at a predetermined angle to the discharging direction of the cut-out member.

3. The cutter according to claim 1, wherein said base material remainder discharging means discharges the base material remainder in substantially the same direction as the discharging direction of the member viewed from a width direction of the member.

4. The cutter according to claim 1, wherein tensile strength of the base material remainder in the continuing direction is higher than that of the member in the continuing direction.

5. The cutter according to claim 4, wherein the base material is embossed and an embossing rate of the base material remainder is higher than that of the member.

6. The cutter according to claim 5, wherein said embossing is uniformly applied in the continuing direction of the base material.

7. The cutter according to claim 1, wherein said dividing means divides the base material remainder into two parts by said cutting blade.

8. The cutter according to claim 1, wherein said dividing means comprises cutting-plane-line-forming means which enables to divide the base material remainder into two parts by forming a cutting plane line on the base material remainder along the continuing direction thereof.

9. The cutter according to claim 8, wherein said cutting plane line is a slit.

10. The cutter according to claim 1, wherein said driving mechanism comprises a roller and a rotating mechanism for rotating said roller, and said cutting blade is a blade provided on said roller; and
wherein said rotating mechanism rotates said roller so that said blade presses against the base material, thereby cutting out the member from the base material.

11. The cutter according to claim 1, wherein said member is an absorbent body.

12. (Canceled)

13. A cutting method for cutting out a member by pressing a cutting blade against a continuous sheet base material, comprising the step of:
conveying the base material along a continuing direction;
cutting out the member by pressing said cutting blade against the base material;
discharging the cut-out member;
dividing a base material remainder, which is a remainder of the base material after the member is cut out, into two parts along the continuing direction of the base material; and
discharging the divided base material remainders in the directions away from each other.

14. The cutting method according to claim 13, wherein, in said discharging step, the base material remainder is discharged in a thickness direction of the member at a predetermined angle to the discharging direction of the member.

15. The cutting method according to claim 13, wherein, in said discharging step, the base material remainder is discharged in substantially the same direction as the discharging direction of the member viewed from a width direction of the member.

16. The cutting method according to claim 13, wherein the base material is embossed beforehand so as to increase an embossing rate of the base material remainder higher than that of the member.

17. The cutting method according to claim 16, wherein said embossing is uniformly applied on the base material in the continuing direction thereof.

18. The cutting method according to claim 13, wherein, in said cutting step, the base material remainder is divided into two by said cutting blade.

19. The cutting method according to claim 13, wherein, in said cutting step, the base material remainder is divided into two by forming a slit on the base material remainder along the continuing direction.

20. The cutting method according to claim 13, wherein, in said cutting step, said cutting blade is provided on a roller and said cutting blade is pressed against the base material by rotating said roller so as to cut out a member from the base material.

21. (Canceled)
